(19) United States
(12) Patent Application Publication
(10) Pub. No.: US 2022/0044200 A1
(43) Pub. Date: Feb. 10, 2022

(54) MATCHING BUSINESS NEED DOCUMENTS

(71) Applicant: NEC Laboratories America, Inc., Princeton, NJ (US)

(72) Inventors: Bo Zong, West Windsor, NJ (US); Yanchi Liu, Monmouth Junction, NJ (US); Haifeng Chen, West Windsor, NJ (US); Xuchao Zhang, Elkridge, MD (US)

(21) Appl. No.: 17/391,499

(22) Filed: Aug. 2, 2021

Related U.S. Application Data
(60) Provisional application No. 63/062,005, filed on Aug. 6, 2020.

(51) Int. Cl. G06Q 10/10; G06Q 50/04; G06N 20/20; G06F 16/2453; G05B 19/4155; G06F 40/30

(52) U.S. Cl. CPC G06Q 10/10; G06Q 50/04; G06N 20/20; G05B 2219/31368; G05B 19/4155; G06F 40/30; G06F 16/2453

(57) ABSTRACT

A method performs actions based on business need matching. A set of business need documents are filtered for relevance with respect to a query business need document to remove irrelevant documents based on business need relevance criteria. Hidden business intentions in remaining business need documents are extracted from the set after the filtering. For the query document with respect to the remaining business need documents, the following are computed: a business intention-based matching score, a business entity-based matching score, and an action modeling based matching score. Using an ensemble method, the scores are integrated into a final score, where higher scoring ones of the remaining business need documents more match a business need of the query business need document. Using an automated manufacturing system, a hardware item is co-manufactured responsive to a joint manufacturing venture derived from the final score.

### RELATED APPLICATION INFORMATION

This application claims priority to U.S. Provisional Patent Application No. 63/062,005, filed on Aug. 6, 2020, incorporated herein by reference in its entirety.

### BACKGROUND

### Technical Field

The present invention relates to document processing and more particularly to matching business need documents.

### Description of the Related Art

Existing methods that evaluate document relevance are based on full text processing by a human which is unduly burdensome. Thus, there is a need for evaluating document relevance without full text processing by a human.

Consider the following example.

Document #1 from Company A states: “We are looking for suppliers that could provide food products for grocery stores . . . ”

Document #2 from Company B states: “We are looking for sale channels for organic vegetables . . . ”

Document #3 from Company C states: “We provide enterprise-level cybersecurity services . . . ”

If we treat Document #1 from Company A as the query, Document #2 from Company B could be a good match, while Document #3 from Company C may not be a good fit.

While a financial institution may provide a digital platform to host such documents for a variety of companies, it is simply cumbersome with low efficiency if one recruits human experts to manually review and match documents based on understanding in business needs, as valuable business opportunities still remain uncovered due to low productivity.

A machine learning based Artificial Intelligence (AI) system is a promising direction to enable automated business need document matching. However, it is difficult for existing techniques to deal with the following technical challenges.

True intention is hidden in noisy human-prepared descriptions. Unlike the examples shown above, real-life business need descriptions could be complex. For example, some business needs are complex by their nature. Moreover, additional complexity could be brought by specific language presentation choices. Further, business-need documents could include other relevant or irrelevant information, such as a company self-introduction for context clarification, an expectation or future planning for potential collaboration, and so on. Due to the aforementioned complexities, it is difficult to identify the key sentences that express true intention or true need from business-need documents.

Even if one is directly given the sentences that express business needs, it is still difficult to extract which words or phrases are relevant. A naïve method may utilize named entities to evaluate relevance between documents, but named entities may not be business-need related, bringing significant amount of noise.

Limited label information. Even though there could be some label information, they are insufficient to learn complex models that enable automated intention discovery.

### SUMMARY

According to aspects of the present invention, a computer-implemented method is provided for performing actions based on business need matching. The method includes filtering a set of business need documents for relevance with respect to a query business need document to remove irrelevant documents based on business need relevance criteria. The method further includes extracting hidden business intentions in remaining business need documents from the set after the filtering. The method also includes computing, by a hardware processor for the query document with respect to the remaining business need documents, a business intention-based matching score that matches document intentions, a business entity-based matching score that matches document business entities, and an action modeling based matching score that matches document action features. The method additionally includes integrating, using an ensemble method, the business intention-based matching score, the business entity-based matching score, and the action modeling based matching score into a final score, where higher scoring ones of the remaining business need documents more match a business need of the query business need document. The method further includes co-manufacturing, using an automated manufacturing system, a hardware item responsive to a joint manufacturing venture derived from the final score.

According to other aspects of the present invention, a computer program product is provided for performing actions based on business need matching. The computer program product includes a non-transitory computer readable storage medium having program instructions embodied therewith. The program instructions are executable by a computer to cause the computer to perform a method. The method includes filtering, by a hardware processor of the computer, a set of business need documents for relevance with respect to a query business need document to remove irrelevant documents based on business need relevance criteria. The method further includes extracting, by the hardware processor, hidden business intentions in remaining business need documents from the set after the filtering. The method also includes computing, by the hardware processor for the query document with respect to the remaining business need documents, a business intention-based matching score that matches document intentions, a business entity-based matching score that matches document business entities, and an action modeling based matching score that matches document action features. The method additionally includes integrating, by the hardware processor using an ensemble method, the business intention-based matching score, the business entity-based matching score, and the action modeling based matching score into a final score, where higher scoring ones of the remaining business need documents more match a business need of the query business need document. The method further includes co-manufacturing, using an automated manufacturing system coupled to the computer, a hardware item responsive to a joint manufacturing venture derived from the final score.

According to yet other aspects of the present invention, a computer processing system is provided for performing actions based on business need matching. The computer processing system includes a memory device for storing program code. The computer processing system further includes a hardware processor for running the program code to filter a set of business need documents for relevance with respect to a query business need document to remove irrelevant documents based on business need relevance criteria. The hardware processor further runs the program code to extract hidden business intentions in remaining business need documents from the set after the filtering. The hardware processor also runs the program code to compute, for the query document with respect to the remaining business need documents, a business intention-based matching score that matches document intentions, a business entity-based matching score that matches document business entities, and an action modeling based matching score that matches document action features. The hardware processor additionally runs the program code to integrate, using an ensemble method, the business intention-based matching score, the business entity-based matching score, and the action modeling based matching score into a final score, where higher scoring ones of the remaining business need documents more match a business need of the query business need document. The hardware processor further runs the program code to co-manufacture, using an automated manufacturing system operatively coupled to the hardware processor, a hardware item responsive to a joint manufacturing venture derived from the final score.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 is a block diagram showing an exemplary scenario, in accordance with an embodiment of the present invention;

FIG. 3 is a block diagram showing an exemplary system for business need document matching, in accordance with an embodiment of the present invention;

FIG. 4 is a flow diagram showing an exemplary method for an offline preprocessing phase, in accordance with an embodiment of the present invention;

FIG. 5 is a flow diagram showing an exemplary method for an online query processing phase, in accordance with an embodiment of the present invention;

FIG. 6 is a flow diagram further showing block 420 of the method of FIG. 4, in accordance with an embodiment of the present invention;

FIG. 7 is a flow diagram further showing block 430 of the method of FIG. 4, in accordance with an embodiment of the present invention;

FIG. 8 is a flow diagram further showing block 440 of the method of FIG. 4, in accordance with an embodiment of the present invention;

FIG. 9 is a flow diagram further showing block 520 of the method of FIG. 5, in accordance with an embodiment of the present invention; and

FIG. 10 is a flow diagram further showing block 530 of the method of FIG. 5, in accordance with an embodiment of the present invention.

### DETAILED DESCRIPTION OF PREFERRED EMBODIMENTS

Embodiments of the present invention are directed to matching business need documents.

Embodiments of the present invention provide a general framework that aims to help companies develop business partnerships based on their business-need documents. Embodiments of the present invention review business-need documents and deliver recommendations for business partnership, playing the role that is served by human experts in conventional systems.

Unlike existing methods that evaluate document relevance based on full text processing, embodiments of the present invention extract sentences that are relevant to business need expression, and focus on analysis over such sentences.

Unlike existing methods that evaluate relevance between sentences based on named entities, embodiments of the present invention focus on extracting business related entities, and remove noise from general entities.

Unlike existing methods that rely on single perspectives, embodiments of the present invention consider multiple perspectives and use ensemble methods to synthesize possibly weak modules with limited coverage into one strong module with wide coverage.

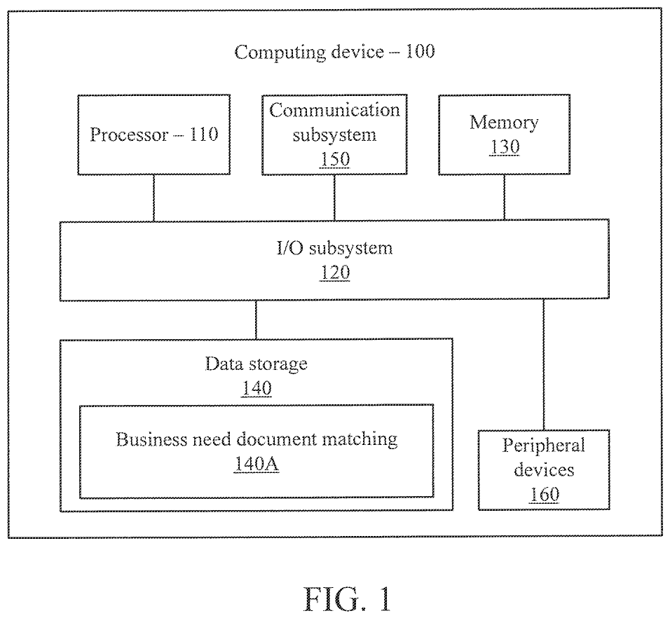

FIG. 1 is a block diagram showing an exemplary computing device 100, in accordance with an embodiment of the present invention. The computing device 100 is configured to perform business need document matching.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for business need document matching. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices. The peripherals can also include a system such as a hardware item manufacturing system. In other embodiments, system 100 can be operatively coupled to a hardware item manufacturing system.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

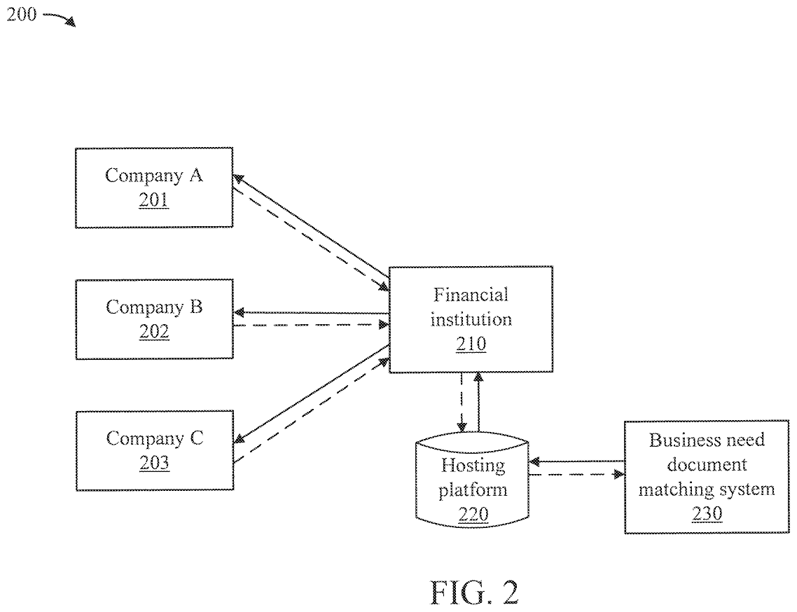

FIG. 2 is a block diagram showing an exemplary scenario 200, in accordance with an embodiment of the present invention.

The scenario 200 involves companies A 201, B 202, and C 203, a financial institution 210, a digital platform 220 hosting business need documents, and a business need document matching system 230. Companies A 201, B 202, and C 203 provide documents to the financial institution 210 for evaluating relevance with respect to each other. The financial institution 210 provides the documents to the digital platform 220, where they are accessed by the business need document matching system 230 for review (relevance evaluation) as described in further detail herein. A decision making output is provided by the business need document matching system 230 that is provided to the companies A201, B 202, and C 203 for their consideration.

In other embodiments, the companies A 201, B 202, and C 203 can directly provide their documents to platform 220 or to business need document matching system 230. These and other variations of scenario 200 are readily determined by one of ordinary skill in the art, while maintaining the spirit of the present invention.

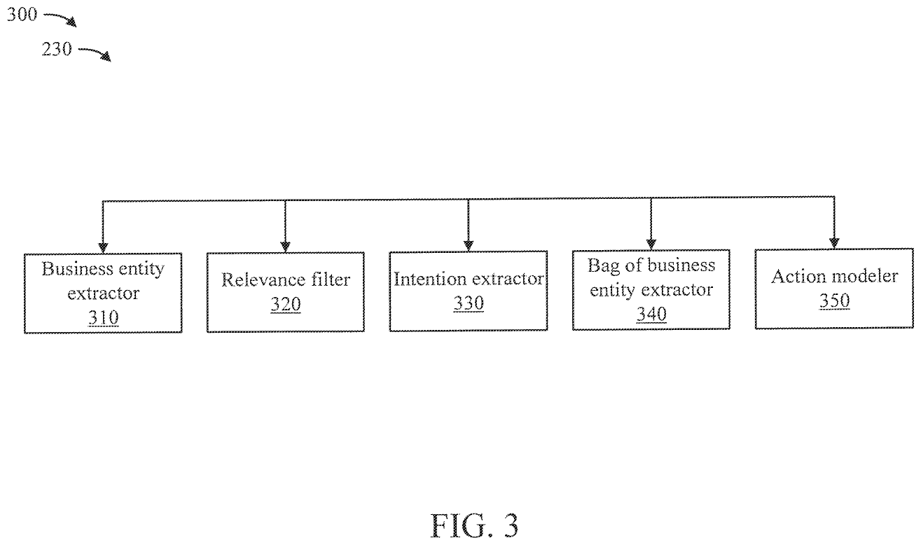

FIG. 3 is a block diagram showing an exemplary system 300 for business need document matching, in accordance with an embodiment of the present invention. System 300 further illustrates business need document matching system 230 of FIG. 2.

System 300 includes a business entity extractor 310, a relevance filter 320, an intention extractor 330, a bag of business entity extractor 340, and an action modeler 350.

The business entity extractor 310 extracts key nouns or phrases that indicate company needs.

The relevance filter 320 ranks candidate documents based on their relevance, and removes those documents which are unlikely to be relevant for business-need matching.

The intention extractor 330 is used to discover sentences that express intentions or needs.

The bag of business entity extractor 340 is used to deal with cases where intention in documents is weakly expressed or difficult to find.

The action modeler 350 uses non-text data, such as industry category, user provided side information and so on, along with limited label information to discover the correlation between non-text data and matching labels. The action modeler 350 provides an orthogonal angle to discover potential business partnership.

System 300 includes an offline preprocessing phase and an online query processing phase.

In the offline preprocessing phase, system 300 goes through individual business-need documents and extracts their business entities. In addition, the action modeler 350 is trained in the offline preprocessing phase.

In the online processing phase, given a query document, system 300 first uses relevance filter 320 to remove those documents that are unlikely to matched. For the remaining documents, the system uses the intention extractor 330 to discover possible intentions hidden in documents. System 300 computes an intention-based matching score, bag-of-biz-entity based matching score, and action modeling based matching score. By an ensemble method, three scores are integrated into one final score where higher scored candidates are more likely to match query documents' business need.

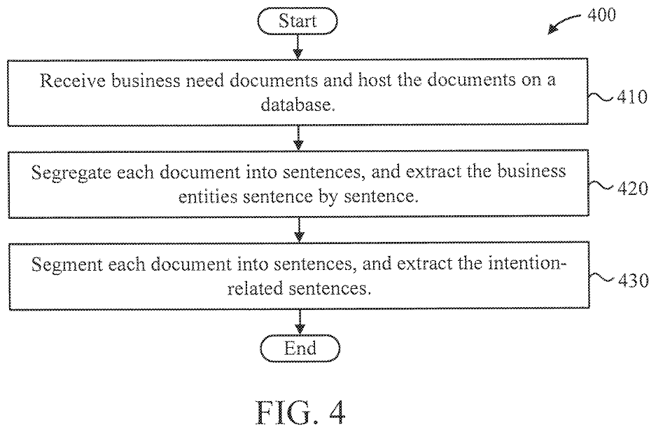

FIG. 4 is a flow diagram showing an exemplary method 400 for an offline preprocessing phase, in accordance with an embodiment of the present invention.

At block 410, receive business need documents and host the documents on a database.

At block 420, segregate each document into sentences, and extract the business entities sentence by sentence.

At block 430, segment each document into sentences, and extract the intention-related sentences.

At block 440, extract non-text features from each document, and train a function that maps the non-text features into a multi-dimensional vector. Such a learned function is also called an action model.

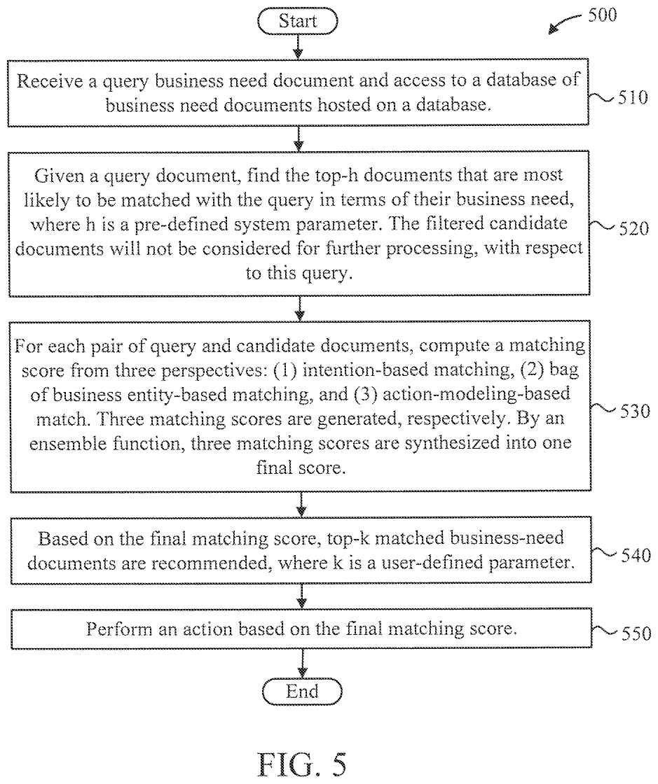

FIG. 5 is a flow diagram showing an exemplary method 500 for an online query processing phase, in accordance with an embodiment of the present invention.

At block 510, receive a query business need document and access to a database of business need documents hosted on a database. A query business-need document is a specific document of interest from a user. Note that the query document is also one of the documents in the database. The database of business-need documents are the same set of documents discussed in step 410.

At block 520, given a query document, find the top-h documents that are most likely to be matched with the query in terms of their business need, where h is a pre-defined system parameter. The filtered candidate documents will not be considered for further processing, with respect to this query.

At block 530, for each pair of query and candidate documents, compute a matching score from three perspectives: (1) intention-based matching, (2) bag of business entity-based matching, and (3) action-modeling-based match. Three matching scores are generated, respectively. By an ensemble function, three matching scores are synthesized into one final score.

At block 540, based on the final matching score, top-k matched business-need documents are recommended, where k is a user-defined parameter.

At block 550, perform an action based on the final matching score. The action can be forming a joint business venture and performing the joint business venture. Regarding the joint venture, the same can be directed to co-manufacturing an item, co-packaging an item, co-marketing an item, co-selling an item, and/or so forth. The item can be a hardware item, a processor-based item, and so forth.

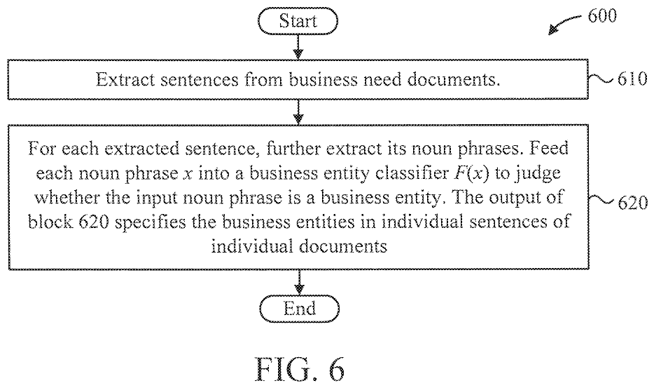

FIG. 6 is a flow diagram further showing block 420 of method 400 of FIG. 4, in accordance with an embodiment of the present invention.

At block 610, extract sentences from business need documents.

At block 620, for each extracted sentence, further extract its noun phrases. Feed each noun phrase x into a business entity classifier F(x) to judge whether the input noun phrase is a business entity. The output of block 620 specifies the business entities in individual sentences of individual documents.

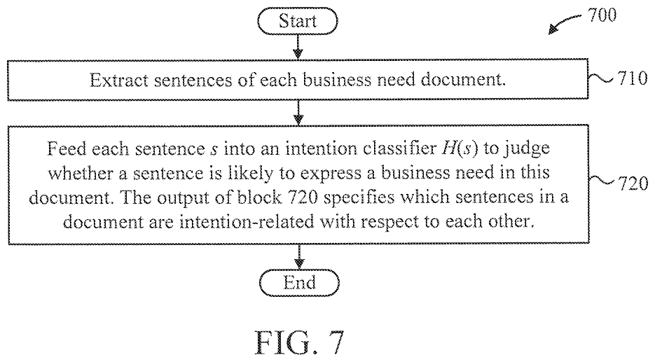

FIG. 7 is a flow diagram further showing block 430 of method 400 of FIG. 4, in accordance with an embodiment of the present invention.

At block 710, extract sentences of each business need document.

At block 720, feed each sentence s into an intention classifier H(s) to judge whether a sentence is likely to express a business need in this document. The output of block 720 specifies which sentences in a document are intention-related with respect to each other.

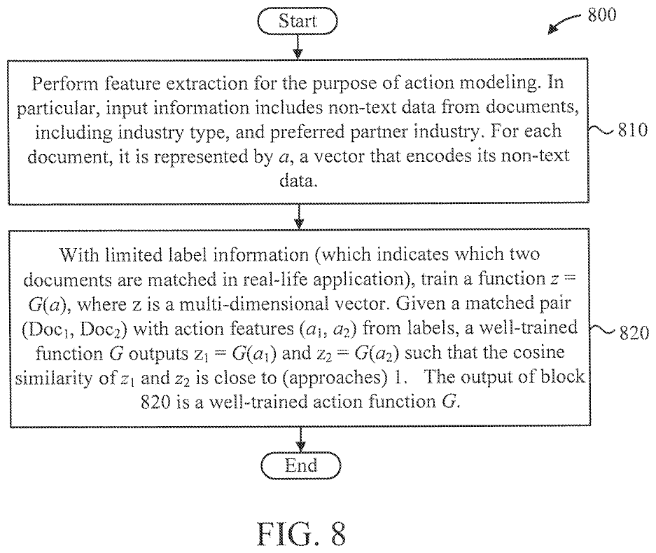

FIG. 8 is a flow diagram further showing block 440 of method 400 of FIG. 4, in accordance with an embodiment of the present invention.

At block 810, perform feature extraction for the purpose of action modeling. In particular, input information includes non-text data from documents, including industry type, and preferred partner industry. For each document, it is represented by a, a vector that encodes its non-text data.

At block 820, with limited label information (which indicates which two documents are matched in real-life application), train a function z=G(a), where z is a multi-dimensional vector. Given a matched pair (Doc₁, Doc₂) with action features (a₁, a₂) from labels, a well-trained function G outputs z₁=G(a₁) and z₂=G(a₂) such that the cosine similarity of z₁ and z₂ is close to (approaches) 1. The output of block 820 is a well-trained action function G.

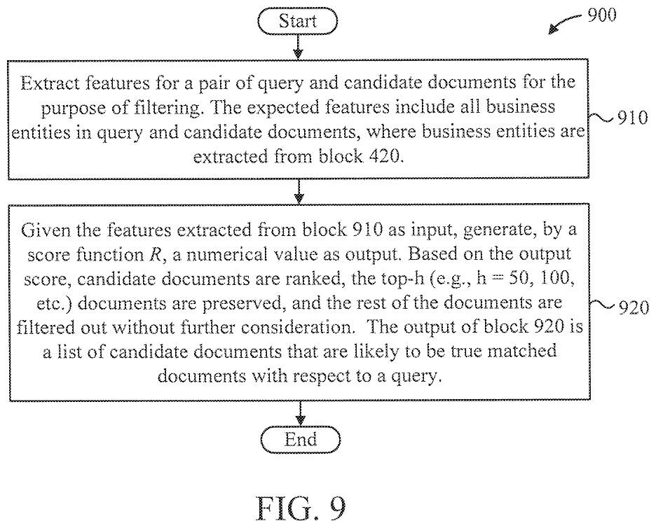

FIG. 9 is a flow diagram further showing block 520 of method 500 of FIG. 5, in accordance with an embodiment of the present invention.

At block 910, extract features for a pair of query and candidate documents for the purpose of filtering. The expected features include all business entities in query and candidate documents, where business entities are extracted from block 420.

At block 920, given the features extracted from block 910 as input, generate, by a score function R, a numerical value as output. Intuitively, a lower output numerical value means the candidate document is more unlikely to match the query in terms of business need. Based on the output score, candidate documents are ranked, the top-h (e.g., h=50, 100, etc.) documents are preserved, and the rest of the documents are filtered out without further consideration. The output of block 920 is a list of candidate documents that are likely to be true matched documents with respect to a query.

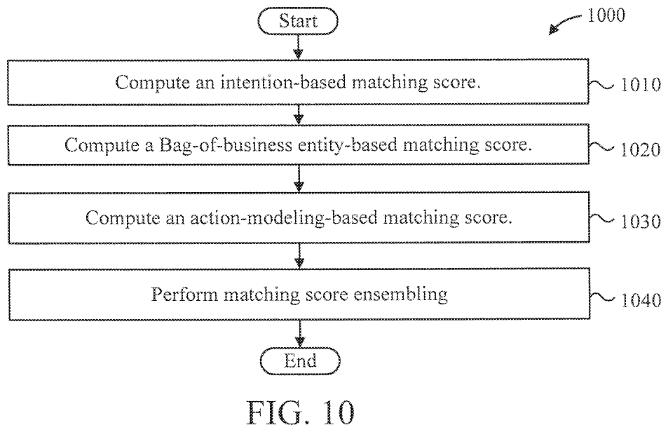

FIG. 10 is a flow diagram further showing block 530 of method 500 of FIG. 5, in accordance with an embodiment of the present invention. Given a pair of query and candidate document (Doc_{q}, Doc_{c}), three scores are computed as follows.

At block 1010, compute an intention-based matching score. Let T_{q} and T_{c} be biz-entities appearing in intention-related sentences extracted from blocks 420 and 430. The matching score mₐ is evaluated by the following equation:

$${m}_{a} = {\sum }_{{e}_{q} ∈ {T}_{q}} {w}_{{e}_{q}} {max}_{{e}_{c} ∈ {T}_{c}} \frac{{v}_{{e}_{q}} \cdot {v}_{{e}_{c}}}{‖ {v}_{{e}_{q}} ‖ ‖ {v}_{{e}_{c}} ‖} ,$$

where vₑ denotes the vector semantic representation (e.g., word2vec) for entity e, and wₑ is an importance-based scalar (e.g., inverse document frequency) for biz-entity e. For each biz-entity in T_{q}, the above equation looks for its best match in T_{c}.

At block 1020, compute a Bag-of-business entity-based matching score. Let T_{q} and T_{c} be business entities appearing in Doc_{q} and Doc_{c}, respectively, extracted from block 420. The matching score m_{b} is evaluated by the following equation,

$${m}_{b} = {\sum }_{{e}_{q} ∈ {T}_{q}} {w}_{{e}_{q}} {max}_{{e}_{c} ∈ {T}_{c}} \frac{{v}_{{e}_{q}} \cdot {v}_{{e}_{c}}}{‖ {v}_{{e}_{q}} ‖ ‖ {v}_{{e}_{c}} ‖} ,$$

where vₑ denotes the vector semantic representation (e.g., word2vec) for entity e, and wₑ is an importance-based scalar (e.g., inverse document frequency) for business entity e. For each business entity in T_{q}, the above equation looks for its best match in T_{c}.

At block 1030, compute an action-modeling-based matching score. Let G be the action function learned from block 740, a_{q} be the action features from Doc_{q}, and a_{c} be the action features from Doc_{c}. The matching score m_{c}, is evaluated by the following equation,

$${m}_{c} = \frac{G ( {a}_{q} ) \cdot G ( {a}_{c} )}{‖ G ( {a}_{q} ) ‖ ‖ G ( {a}_{c} ) ‖}$$

At block 1040, perform matching score ensembling. Given three matching scores (mₐ, m_{b}, m_{c}) computed from blocks 710-730, the system 300 synthesizes it into a final matching score m_{f} by the following equation,

m_{f}=λₐmₐ+λ_{b}m_{b}+λ_{c}m_{c},

where λₐ, λ_{b}, λ_{c}≥0 and λₐ+λ_{b}+λ_{c}=1. Note that λₐ, λ_{b} and λ_{c}, can be pre-defined by heuristics or learned by existing ensemble learning methods.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for performing actions based on business need matching, comprising:
filtering a set of business need documents for relevance with respect to a query business need document to remove irrelevant documents based on business need relevance criteria;
extracting hidden business intentions in remaining business need documents from the set after the filtering;
computing, by a hardware processor for the query document with respect to the remaining business need documents, a business intention-based matching score that matches document intentions, a business entity-based matching score that matches document business entities, and an action modeling based matching score that matches document action features;
integrating, using an ensemble method, the business intention-based matching score, the business entity-based matching score, and the action modeling based matching score into a final score, where higher scoring ones of the remaining business need documents more match a business need of the query business need document; and
co-manufacturing, using an automated manufacturing system, a hardware item responsive to a joint manufacturing venture derived from the final score.

2. The computer-implemented method of claim 1, wherein said filtering, extracting, computing, and integrating steps are comprised in an online query processing phase.

3. The computer-implemented method of claim 1, wherein said filtering step finds top-h documents matched with the query document in terms of their business need, where h is a pre-defined system parameter.

4. The computer-implemented method of claim 1, further comprising performing action feature extraction from the set of business need documents to extract non-text data from the set of business need documents into a vector used to calculate the action modeling based matching score.

5. The computer-implemented method of claim 1, wherein the action modeling based matching score is computed using label information indicating a matching between the query business need document and a business need document from the remaining business need documents to train a function.

6. The computer-implemented method of claim 1, wherein the query business need document is comprised in the set of business need documents.

7. The computer-implemented method of claim 1, wherein the business intention-based matching score, the business entity-based matching score, and the action modeling based matching score are computing by pairwise comparing the query business need document to a respective one of the remaining business need documents.

8. The computer-implemented method of claim 1, wherein the business intention-based matching score is computed based on (i) a sentence level vector semantic representation of a business entity in intention-related sentences in the remaining business need documents and (ii) a document level frequency importance-based scalar of the business entity in the remaining business need documents.

9. The computer-implemented method of claim 1, wherein the business entity-based matching score is computed based on (i) a document level vector semantic representation of a business entity in the remaining business need documents and (ii) a document level frequency importance-based scalar of the business entity in the remaining business need documents.

10. The computer-implemented method of claim 1, wherein the action modeling based matching score is computed based on (i) document level action features in the remaining business need documents and (ii) an action function applied to the document level action features.

11. A computer program product for performing actions based on business need matching, the computer program product comprising a non-transitory computer readable storage medium having program instructions embodied therewith, the program instructions executable by a computer to cause the computer to perform a method comprising:
filtering, by a hardware processor of the computer, a set of business need documents for relevance with respect to a query business need document to remove irrelevant documents based on business need relevance criteria;
extracting, by the hardware processor, hidden business intentions in remaining business need documents from the set after the filtering;
computing, by the hardware processor for the query document with respect to the remaining business need documents, a business intention-based matching score that matches document intentions, a business entity-based matching score that matches document business entities, and an action modeling based matching score that matches document action features;
integrating, by the hardware processor using an ensemble method, the business intention-based matching score, the business entity-based matching score, and the action modeling based matching score into a final score, where higher scoring ones of the remaining business need documents more match a business need of the query business need document; and
co-manufacturing, using an automated manufacturing system coupled to the computer, a hardware item responsive to a joint manufacturing venture derived from the final score.

12. The computer program product of claim 11, wherein said filtering, extracting, computing, and integrating steps are comprised in an online query processing phase.

13. The computer program product of claim 11, wherein said filtering step finds top-h documents matched with the query document in terms of their business need, where h is a pre-defined system parameter.

14. The computer program product of claim 11, further comprising performing action feature extraction from the set of business need documents to extract non-text data from the set of business need documents into a vector used to calculate the action modeling based matching score.

15. The computer program product of claim 11, wherein the action modeling based matching score is computed using label information indicating a matching between the query business need document and a business need document from the remaining business need documents to train a function.

16. The computer program product of claim 11, wherein the business intention-based matching score, the business entity-based matching score, and the action modeling based matching score are computing by pairwise comparing the query business need document to a respective one of the remaining business need documents.

17. The computer program product of claim 11, wherein the business intention-based matching score is computed based on (i) a sentence level vector semantic representation of a business entity in intention-related sentences in the remaining business need documents and (ii) a document level frequency importance-based scalar of the business entity in the remaining business need documents.

18. The computer program product of claim 11, wherein the business entity-based matching score is computed based on (i) a document level vector semantic representation of a business entity in the remaining business need documents and (ii) a document level frequency importance-based scalar of the business entity in the remaining business need documents.

19. The computer program product of claim 11, wherein the action modeling based matching score is computed based on (i) document level action features in the remaining business need documents and (ii) an action function applied to the document level action features.

20. A computer processing system for performing actions based on business need matching, comprising:
a memory device for storing program code; and
a hardware processor for running the program code to:
filter a set of business need documents for relevance with respect to a query business need document to remove irrelevant documents based on business need relevance criteria;
extract hidden business intentions in remaining business need documents from the set after the filtering;
compute, for the query document with respect to the remaining business need documents, a business intention-based matching score that matches document intentions, a business entity-based matching score that matches document business entities, and an action modeling based matching score that matches document action features;
integrate, using an ensemble method, the business intention-based matching score, the business entity-based matching score, and the action modeling based matching score into a final score, where higher scoring ones of the remaining business need documents more match a business need of the query business need document; and
co-manufacture, using an automated manufacturing system operatively coupled to the hardware processor, a hardware item responsive to a joint manufacturing venture derived from the final score.
